(19) United States
(12) Patent Application Publication
(10) Pub. No.: US 2021/0049304 A1
(43) Pub. Date: Feb. 18, 2021

(54) CHARACTER FINGERPRINTING IN TEXT COMPOSITIONS

(71) Applicant: International Business Machines Corporation, Armonk, NY (US)

(72) Inventors: Lohitashwa Thyagaraj, Vidyaranyapura (IN); Santosh Rao, Bangalore (IN); Satyendra Kumar, Bengaluru (IN); Shubham Srivastava, Bengaluru (IN)

(21) Appl. No.: 16/537,914

(22) Filed: Aug. 12, 2019

(51) Int. Cl. G06F 21/64; G06F 21/62

(52) U.S. Cl. CPC G06F 21/64; G06F 21/6218

(57) ABSTRACT

A computer-implemented method can include obtaining a first text composition and obtaining first user data of a first user. The method can further include generating a first set of character fingerprinting rules that corresponds to the first user. The method can further include performing a first modification of the first text composition, according to the first set of fingerprinting rules. The first modification can result in a first fingerprinted text composition that corresponds to the first user.

### BACKGROUND

The present disclosure relates to data security, and more specifically, to security for text compositions.

Data security methods can include monitoring resources, such as web pages, blogs, and articles to identify confidential subject matter that may have been compromised. Other data security methods can include substituting confidential information in documents with random characters to protect the confidential information.

### SUMMARY

According to embodiments of the present disclosure, a computer-implemented method can include obtaining, by a character fingerprinting system, a first text composition. The method can further include obtaining, by the character fingerprinting system, first user data of a first user. The method can further include generating, by the character fingerprinting system, a first set of character fingerprinting rules. The first set of character fingerprinting rules can correspond to the first user. The method can further include performing a first modification, by the character fingerprinting system, of the first text composition. The performing of the first modification can be done according to the first set of character fingerprinting rules. The first modification can result in a first fingerprinted text composition. The first fingerprinted text composition can correspond to the first user.

A system and a computer program product corresponding to the above method are also included herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example computing environment that includes a set of user devices, a computing device, a character fingerprinting system, and a network, in accordance with embodiments of the present disclosure.

FIG. 2 depicts a flowchart of an example method for generating a fingerprinted text composition and identifying a second text composition that matches a fingerprinted text composition, in accordance with embodiments of the present disclosure.

FIG. 3 depicts the representative major components of a computer system that can be used in accordance with embodiments of the present disclosure.

FIG. 4 depicts a cloud computing environment according to an embodiment of the present disclosure.

FIG. 5 depicts abstraction model layers according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to data security; more particular aspects relate to generating traceable text compositions. While the present disclosure is not necessarily limited to such applications, various aspects of the disclosure can be appreciated through a discussion of various examples using this context.

Entities such as corporations, organizations, and government agencies, can be susceptible to improper publications of confidential communications. While tools can be used to locate such improper publications (e.g., by regularly searching the Internet for copies of confidential communications), identifying potential sources of the improper publications can present a separate challenge. For example, if a company's network is compromised, resulting in one or more confidential documents being published, tools can locate the one or more confidential documents on the Internet, but such tools may not be able to provide information about a compromised source, such as a particular device within the company's network that may have been improperly accessed.

To address these and other problems, embodiments of the present disclosure include a character fingerprinting system that can generate and apply a character fingerprint to a text composition, such as a confidential document, resulting in a fingerprinted text composition that can be traceable to a user or to a user device.

In some embodiments, a text composition can be a communication containing text, such as a document, email message, or a text message. In some embodiments, a character fingerprint can be a unique, predetermined sequence of characters (e.g., a predetermined pattern of spaces, punctuation, formatting, and/or alphanumeric characters) that corresponds to a user and is arranged throughout a text composition. A character fingerprint can be generated by the character fingerprinting system according to a set of character fingerprinting rules. In some embodiments, the character fingerprinting rules can be generated by the character fingerprinting system. For example, in some embodiments, a character fingerprinting system can generate a first set of character fingerprinting rules that includes modifying a text composition such that an additional space is added after the fourth word of each paragraph of the text composition, and a font size of the last letter “e” appearing in each paragraph of the text composition is reduced by one half of a point size. In this example, the character fingerprinting system can correlate the first set of character fingerprinting rules with a first user by storing the first set of character fingerprinting rules within a first user profile. Further, in this example, the character fingerprinting system can apply the first set of character fingerprinting rules to the text composition by modifying the text composition according to the character fingerprinting rules, resulting in a first fingerprinted text composition. The first fingerprinted text composition can correspond to the first user as a result of the correlation between the first set of character fingerprinting rules and the first user. Additionally, in this example, when the first user requests to view the text composition using a first user device (e.g., an electronic device such as a computer, tablet, or mobile telephone), the first user device will display the first fingerprinted text composition, as opposed to the unmodified text composition. In some embodiments, a fingerprinted text composition can retain substantially similar or identical substantive information (e.g., content, meaning, central idea, etc.) to another fingerprinted text composition or to an unmodified text composition, as a character fingerprint can modify the format (e.g., font, spacing, punctuation, etc.) of a text composition without modifying the substance (e.g., content, meaning, central idea, etc.) of the text composition.

By generating a fingerprinted text composition that can correspond to a user, embodiments of the present disclosure can provide multiple beneficial features. For example, by integrating a character fingerprint into the text of a text composition, embodiments of the present disclosure can provide a fingerprint that can be discernible regardless of the format of the text composition. For example, regardless of whether a fingerprinted text composition according to embodiments of the present disclosure is printed, copied using screen-capture software, or photographed on the screen of a user device, the fingerprinted text composition can be discernible whenever the text of the text composition is discernible. Accordingly, a fingerprinted text composition according to embodiments of the present disclosure can be more effective for tracing a text composition to a user than other traceable means, such as a username within metadata of a document. The latter may not be effective for tracing from a format such as a photographed screen of a user device, as the photographed screen may not include metadata of the document. Additionally, a character fingerprint according to embodiments of the present disclosure can be effectively “hidden in plain sight;” thus, it can be less susceptible to removal than a more readily ascertainable marker, such as a document watermark. For example, a user who is aware of a document watermark can attempt to remove or obscure the document watermark to eliminate the traceability of the document. However, a user may not recognize a character fingerprint according to embodiments of the present disclosure; thus, it can be less susceptible to removal by the user. Additionally, a character fingerprint according to an embodiment of the present disclosure can provide information that can help identify a compromised device or account. For example, while a tool for finding a confidential document that has been published on the Internet can indicate that a computer has been compromised, the tool may not provide information about a specific computer that may have been compromised. In contrast, based on a character fingerprint that corresponds to a user, embodiments of the present disclosure can provide information about a found confidential document that can indicate that a specific user's computer has been compromised.

In some embodiments of the present disclosure, the character fingerprinting system can generate multiple fingerprinted text compositions from a single text composition, such that each user of a group of users can receive a respective unique fingerprinted text composition. For example, in some embodiments of the present disclosure, three users (a first user, a second user, and a third user) can use collaboration software to draft a report. In this example, the collaboration software includes a character fingerprinting system. Additionally, in this example, a list of items in the report can be numbered. Further in this example, when the first user requests to view the report via a first user device, the character fingerprinting system can transmit a first fingerprinted report to the first user device. The first fingerprinted report can correspond to the first user's e-mail address and can include circular bullet points, instead of numbers, for the list of items in the report. Further in this example, when the second user requests to view the report via a second user device, the character fingerprinting system can transmit a second fingerprinted report to the second user device. The second fingerprinted report can correspond to the second user's employee ID number and can include square bullet points, instead of numbers, for the list of items in the report. Further in this example, when the third user requests to view the report via a third user device, the character fingerprinting system can transmit a third fingerprinted report to the third user device. The third fingerprinted report can correspond to the third user's software license number and can include triangular bullet points, instead of numbers, for the list of items in the report. By generating such tailored fingerprinted text compositions for each user who accesses a single text composition, embodiments of the present disclosure can provide text compositions that can be traceable to each user.

In some embodiments of the present disclosure, the character fingerprinting system can obtain a text composition from a source, such as a public chat room, and compare the obtained text composition to a set of stored fingerprinted text compositions to determine whether a similarity between the obtained text composition and a stored fingerprinted text composition exceeds a threshold. In some embodiments, the character fingerprinting system can generate a notification if such a similarity threshold is exceeded. For example, in some embodiments, the character fingerprinting system can utilize an Internet search tool to find a text composition having multiple predetermined keywords regarding a company's confidential information (e.g., financial information, trade secret information, organizational information, etc.). In this example, the character fingerprinting system can find such a text composition within a public chat room. Further in this example, the character fingerprinting system can detect a character fingerprint by comparing the found text composition to a stored fingerprinted text composition. For example, the stored fingerprinted text composition can include the following four character fingerprint elements: (1) an additional space after the fifth word of each paragraph; (2) commas substituted for semicolons; (3) the homophone “compliment” substituted for “complement;” and (4) the 100^{th} word and the 200^{th} word being italicized. Further in this example, the stored fingerprinted text composition can correspond to a username of a third user. Further in this example, the character fingerprinting system can detect, in the found text composition, three of the four character fingerprint elements, which can exceed a threshold of two detected character fingerprint elements. In this example, since a threshold number of detected character fingerprint elements has been exceeded, the character fingerprinting system can determine that the found text composition matches the stored fingerprinted text composition corresponding to the third user. In response, the character fingerprinting system can generate a notification, such as an e-mail to a data security manager, regarding the match.

The ability to obtain a text composition and compare it to a stored fingerprinted text composition to determine a potential match can allow embodiments of the present disclosure to not only find text compositions that can be improperly published, but also provide information relevant to a potentially compromised source.

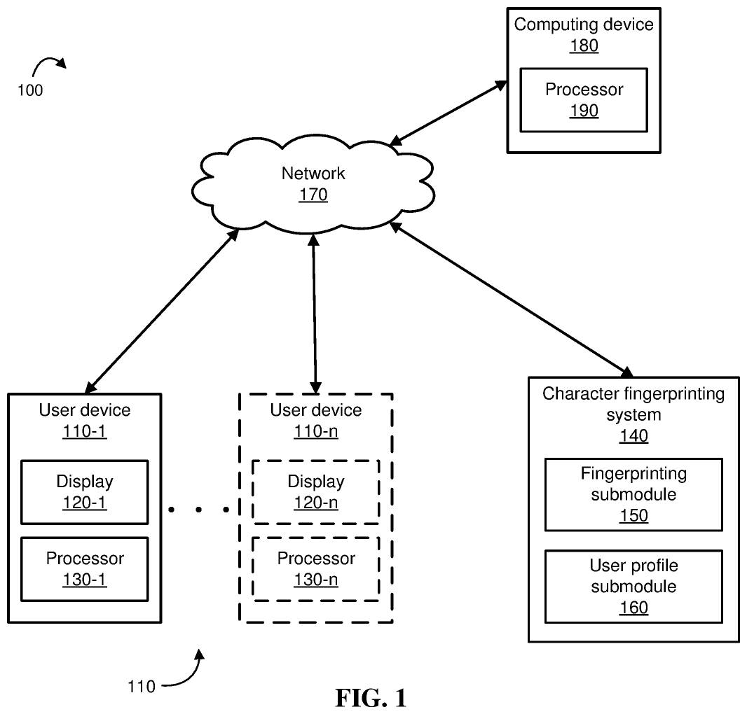

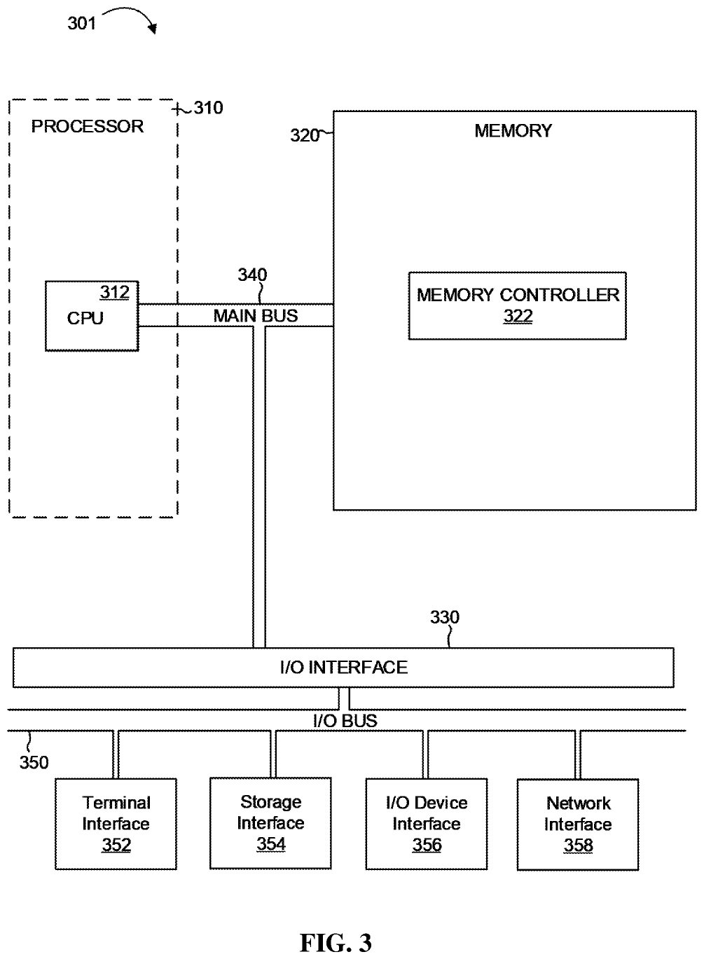

Turning to the figures, FIG. 1 illustrates an example computing environment 100 that includes a set of user devices 110, a computing device 180, a character fingerprinting system 140, and a network 170, in accordance with embodiments of the present disclosure. The set of user devices 110 can include one or more user devices. For example, in some embodiments, the set of user devices 110 can include n devices, where n is an integer greater than zero. For example, n=1 in embodiments in which the set of user devices 110 includes only a first user device 110-1 having a first display 120-1 and a first processor 130-1; n=2 in embodiments in which the set of user devices 110 includes two user devices (a first user device 110-1 having a first display 120-1 and a first processor 130-1 and a second user device 110-2 having a second display 120-2 and a second processor 130-2); and so on. In some embodiments, the set of user devices 110 can include at least one electronic device such as a computer, tablet, or mobile telephone. In some embodiments, one or more of the set of user devices 110, the computing device 180, and the character fingerprinting system 140 can include a computer system such as the computer system 301 shown in FIG. 3. In some embodiments, the computing environment 100 can include a plurality of computing devices 180, character fingerprinting systems 140, and/or networks 170.

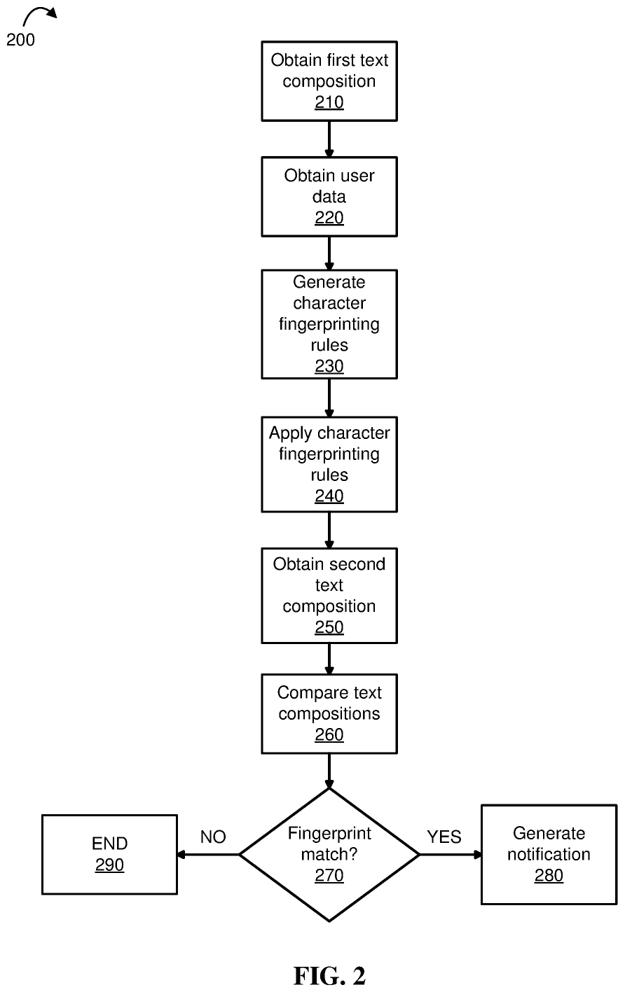

The first user device 110-1 includes a first display 120-1, such as a screen or a touch screen, and a first processor 130-1. In some embodiments, the first display 120-1 can present a text composition, such as a text message, email message, or a document containing text, to a user. In some embodiments, the first processor 130-1 can include programming instructions to perform one or more method steps, such as those described in FIG. 2 below.

The set of user devices 110 can communicate with at least one of the computing device 180 and the character fingerprinting system 140 via one or more networks 170. In some embodiments, the character fingerprinting system 140 can be a computing device, such as a server, having a processor that implements one or more method steps, such as those described in FIG. 2 below. In some embodiments, the character fingerprinting system 140 can include a processor, such as first processor 130-1 or processor 190, that implements one or more method steps, such as those described in FIG. 2 below.

In some embodiments, the character fingerprinting system 140 includes a discrete fingerprinting submodule 150 and user profile submodule 160. In some embodiments, the fingerprinting submodule 150 and the user profile submodule 160 can be integrated into a single device. In some embodiments, the fingerprinting submodule 150 and/or user profile submodule 160 can be located remote from the character fingerprinting system 140.

In some embodiments, the fingerprinting submodule 150 can be configured to obtain and compare text compositions, generate character fingerprinting rules, apply character fingerprinting rules to generate character fingerprints, and generate notifications. In some embodiments, the user profile submodule 160 can be configured to obtain and store user data.

The computing device 180 can be an electronic device such as a server or a computer. In some embodiments, the computing device 180 can be configured to store text compositions that can be obtained by at least one of the set of user devices 110 and the character fingerprinting system 140.

An example operation of an embodiment of the present disclosure that includes two user devices (a first user device 110-1 and a second user device 110-n, where n=2) is discussed below. In this example, the character fingerprinting system 140 can be a component of a collaboration tool that allows a first user operating the first user device 110-1 and a second user operating the second user device 110-2 to view and manipulate a text composition, such as an electronic document. In this example, the electronic document can be stored on the computing device 180. When the first user device 110-1 requests the electronic document, the fingerprinting submodule 150 can obtain the electronic document from the computing device 180, and the user profile submodule 160 can obtain first user data, such as a user name of the first user. Similarly, when the second user device 110-2 requests the electronic document, the fingerprinting submodule 150 can obtain the electronic document from the computing device 180, and the user profile submodule 160 can obtain second user data, such as an employee number of the second user. In this example, the character fingerprinting system 140 can apply a unique, first character fingerprint to the electronic document, resulting in a first fingerprinted electronic document, and the character fingerprinting system 140 can apply a unique, second character fingerprint to the electronic document, resulting in a second fingerprinted electronic document. Thus, in this example, in response to the first user device 110-1 requesting the electronic document, the character fingerprinting system 140 can provide to the first user device 110-1 the first fingerprinted electronic document, and in response to the second user device 110-2 requesting the electronic document, the character fingerprinting system 140 can provide to the second user device 110-2 the second fingerprinted electronic document. In this example, the first user device 110-1 can display the first fingerprinted electronic document to the first user and the second user device 110-2 can display the second fingerprinted electronic document to the second user. In some embodiments, the first fingerprinted electronic document and the second fingerprinted electronic document retain substantially similar or identical information (e.g., content, meaning, etc.) despite the different character fingerprints applied to each document.

Additionally, in this example, the first fingerprinted electronic document corresponds to the first user in that the first character fingerprint is correlated with the user name of the first user. Similarly, in this example, the second fingerprinted electronic document corresponds to the second user in that the second character fingerprint is correlated with the employee number of the second user. By including a character fingerprint that corresponds to a user, embodiments of the present disclosure can provide traceable text compositions, such that a user who is associated with a character fingerprint can be identified by identifying the character fingerprint in a fingerprinted text composition.

FIG. 2 illustrates a flowchart of an example method 200 for generating a fingerprinted text composition and identifying a user corresponding to a fingerprinted text composition, in accordance with embodiments of the present disclosure. The method 200 can be performed by a character fingerprinting system, such as the character fingerprinting system 140 described with respect to FIG. 1. Referring back to FIG. 2, in step 210, the character fingerprinting system can obtain a first text composition. A text composition can be a communication containing text, such as a document, website article, email message, or a text message. In some embodiments, step 210 can include a processor of the character fingerprinting system retrieving the first text composition from a data storage location within the character fingerprinting system or from a data storage location external to the character fingerprinting system, such as a remote server.

In step 220, the character fingerprinting system can obtain user data of a user. User data can include information that can be used to identify a user, such as a user's name, email address, username, identification number, or account number. In some embodiments, the character fingerprinting system can obtain the user data from a source such as a user device or metadata included with a text composition. In some embodiments, the user data can be stored in a user profile.

In step 230, the character fingerprinting system can generate a set of character fingerprinting rules. Character fingerprinting rules can include a set of instructions to modify a text composition such that the text composition includes a character fingerprint (e.g., a unique, predetermined sequence of characters, such as a predetermined pattern of spaces, punctuation, formatting, and/or alphanumeric characters, that corresponds to a user). For example, in some embodiments, a set of character fingerprinting rules can include instructions to modify a text composition such that: (1) the 5^{th}, 10^{th} and 15^{th} instances of a period appearing in the text composition are italicized; (2) the font of every comma appearing in the text composition is changed from Times New Roman to Arial; (3) the color of every letter “a” appearing in the text composition is changed from a standard black color to a 15% lighter black color; and (4) every third instance of the word “amount” appearing in the text composition is changed to the word “quantity.” In some embodiments, the character fingerprinting system can correlate the character fingerprinting rules with a user, such as by storing the character fingerprinting rules within a user profile.

In some embodiments, the character fingerprinting system can generate a unique set of character fingerprinting rules for each user who accesses a text composition. In some embodiments, such rules can be generated when the user requests access to the text composition. For example, in some embodiments, a first user can use a first user device to access a document stored on a shared network drive. In response to the request to access the document, the character fingerprinting system can generate a first set of character fingerprinting rules that is unique to the first user and can be applied to the document as discussed below. Similarly, in this example, a second user can use a second user device to access the same document stored on the shared network drive. In response to the request to access the document, the character fingerprinting system can generate a second set of character fingerprinting rules that is unique to the second user and can be applied to the document as discussed below. In some embodiments, the first set of character fingerprinting rules and the second set of character fingerprinting rules can be stored, respectively, within a first user profile and a second user profile.

In some embodiments, the character fingerprinting rules can be manually selected by a person such as a network administrator. In some embodiments, the character fingerprinting rules can be automatically, randomly generated by a processor of the character fingerprinting system. In some embodiments, the character fingerprinting rules can be generated by the character fingerprinting system according to a hash as described below.

In some embodiments, the character fingerprinting system can generate a hash that corresponds to obtained user data. For example, in some embodiments, the character fingerprinting system can obtain a first user's employee ID number (#/USER1) and generate a random corresponding hash, such as: f(#/USER1)=9ECEB13483D7F187EC014FD6D4854. In some embodiments, the character fingerprinting system can assign a set of character fingerprinting rules to the hash to generate a character fingerprint for a text composition. For example, in some embodiments, the character fingerprinting system can identify each hash character (e.g., 9, E, C, E . . . , in the example hash above) and assign a character fingerprinting rule to each hash character. For example, in some embodiments, the character fingerprinting system can assign the following set of character fingerprinting rules to a hash: if a hash character is a number (n), the character fingerprinting system will add a space before the next nth character in the text composition, and if a hash character is a letter, the character fingerprinting system will change to boldface the first instance of that letter in each paragraph of the text composition. In some embodiments, an entire hash can apply to a portion of the text composition, such as a page of a document. For example, in some embodiments, the character fingerprinting rules discussed above can be assigned to the entire hash discussed above for each page of a document.

As discussed herein, respective character fingerprinting rules can be applied to characters, words, fragments, phrases, sentences, paragraphs, and/or other sections of content. In some embodiments, respective character fingerprinting rules can include for example, a location and a modification. Locations can be defined by position alone (e.g., a third character, a fifth word, a second to last sentence, etc.), by content alone (e.g., all instances of the character “h”, all instances of the word “the”, etc.), and/or by combinations of position and content (e.g., every other instance of the word “and”, each fifth period, etc.).

In addition to the various ways location can be defined discussed above, there are likewise many modifications which can be applied for respective character fingerprinting rules. A non-exhaustive list of modifications can include: (1) substitutions (e.g., replace the character “s” with the symbol “$”, replace “processor” with “CPU”, etc.); (2) capitalization (e.g., capitalize each tenth “t”, capitalize the word “regarding”, etc.); (3) font type (e.g., change a predefined letter or word from one font to another); (4) font size (e.g., change a predefined letter or word from one font size to another); (5) font effects (e.g., apply bold, italics, underline, emboss, strikethrough, or a different font effect to a predefined character or word); (6) font color (e.g., apply predefined color to a predefined character or word); (7) shading (e.g., apply a predefined shading, gradient, or pattern to a predefined character or word); and so on. Further, although not explicitly discussed above, additional respective character fingerprinting rules can be related to page layout (e.g., orientation, margins, indents, page numbers, alignments, etc.).

In step 240, the character fingerprinting system can apply a set of character fingerprinting rules to a text composition by modifying the text composition according to the character fingerprinting rules, resulting in a fingerprinted text composition. A fingerprinted text composition can be a text composition that includes a character fingerprint (e.g., a unique, predetermined sequence of characters, such as a predetermined pattern of spaces, punctuation, formatting, and/or alphanumeric characters, that corresponds to a user). In some embodiments, step 240 can include the character fingerprinting system implementing a set of character fingerprinting rules. For example, continuing with the example hash discussed above, step 240 can include the character fingerprinting system adding a space before every ninth character in a text composition and changing to boldface the first instance of the letter “e” in each paragraph of the text composition. In some embodiments, step 240 can include the character fingerprinting system storing a fingerprinted text composition in a data storage location of the character fingerprinting system or in an external data storage location, such as a remote server. In some embodiments, step 240 can include the character fingerprinting system storing a fingerprinted text composition within a user profile to correlate the fingerprinted text composition to a user.

In some embodiments, step 240 can include the character fingerprinting system transmitting a respective, unique fingerprinted text composition to each user device of a set of user devices. For example, in some embodiments, a character fingerprinting system can include a stored text composition, the stored text composition not having numbered pages. In this example, a first user can request to access the stored text composition with a first user device (e.g., the first user can attempt to open and view the stored text composition on the first user device). Similarly, in this example, a second user can request to access the stored text composition with a second user device. In this example, in response to the first user's request, the character fingerprinting system can generate, based on a first set of character fingerprinting rules, a first fingerprinted text composition that includes centered page numbers in a footer of each page of the first fingerprinted text composition. Further in this example, in response to the second user's request, the character fingerprinting system can generate, based on a second set of character fingerprinting rules, a second fingerprinted text composition that includes right-justified page numbers in a footer of each page of the second fingerprinted text composition. Additionally, in response to the first user's request, the character fingerprinting system can transmit the first fingerprinted text composition to the first user device, and in response to the second user's request, the character fingerprinting system can transmit the second fingerprinted text composition to the second user device. Accordingly, in this example, neither the first user nor the second user will receive access to the stored text composition; rather, each user will receive access to a respective, unique fingerprinted text composition. As a result, in this example, the first fingerprinted text composition can be traceable to the first user and/or the first user device, and the second fingerprinted text composition can be traceable to the second user and/or the second user device.

In step 250, the character fingerprinting system can obtain a second text composition. In some embodiments, the character fingerprinting system can obtain the second text composition from an electronic device, such as a computer, tablet, mobile telephone, or a server. In some embodiments, step 250 can include the character fingerprinting system obtaining the second text composition as a result of an Internet search for a text composition that includes terms or content that is substantially similar or identical to terms or content included in the first text composition. For example, in some embodiments, a first text composition can include a first set of terms that describe a company's confidential information. In this example, the character fingerprinting system can perform an Internet search for a text composition that describes the company's confidential information using a second set of terms that are synonymous or identical to the first set of terms. Further in this example, upon finding such a text composition, the character fingerprinting system can store the found text composition as a second text composition. In some embodiments, the character fingerprinting system can obtain a second text composition from an external resource, such as a search service or a search tool that can perform a search for a text composition that is substantially similar or identical to the first text composition.

In step 260, the character fingerprinting system can compare the second text composition to a fingerprinted text composition to determine whether the second text composition matches the fingerprinted text composition. The second text composition can match the fingerprinted text composition when the two text compositions include the same character fingerprint. For example, a fingerprinted text composition can include a character fingerprint in which the first word of every sentence is underlined. In this example, the character fingerprinting system can compare a second text composition to the fingerprinted text composition to determine whether the first word of every sentence of the second text composition is underlined. If so, the character fingerprinting system can determine that the second text composition matches the fingerprinted text composition.

In some embodiments, in step 260, the character fingerprinting system can determine such a match based on a threshold number of detected character fingerprint elements being exceeded. A character fingerprint element can include one or more features of a character fingerprint. For example, in some embodiments, a character fingerprint can include two character fingerprint elements: (1) all punctuation being italicized and (2) all page numbers appearing in boldface. Continuing with this example, the character fingerprinting system can compare a second text composition to a fingerprinted text composition and detect that the second text composition includes 90% of its punctuation being italicized and 6 of 10 page numbers appearing in boldface. In this example, the character fingerprinting system can determine that the second text composition matches the fingerprinted text composition based on one or more of the following: (a) element 1 being substantially satisfied because the detected italicized punctuation exceeded an 80% threshold and (b) element 2 being substantially satisfied because the detected boldfaced page numbers exceeded a 50% threshold. In some embodiments, thresholds used by the character fingerprinting system to determine a character fingerprint match can be selected by a person such as a network administrator. In some embodiments, such thresholds can be automatically determined by the character fingerprinting system based on statistical calculations or machine learning techniques.

In some embodiments, step 260 can include the character fingerprinting system comparing the second text composition to a plurality of stored fingerprinted text compositions to determine whether the second text composition includes a character fingerprint that matches a character fingerprint of any of the plurality of stored fingerprinted text compositions.

In step 270, if the character fingerprinting system determines that a fingerprint match is present between the second text composition and a fingerprinted text composition, then in step 280, the character fingerprinting system can generate a notification, such as an e-mail to a data security manager regarding the match. Such a notification can include, for example, information related to the second text composition (e.g., a copy of the second text composition, a location of the second text composition, etc.), a user profile or device identifier associated with the fingerprinted text composition, and/or a percent match or probability of match. Otherwise, if the character fingerprinting system does not determine that a fingerprint match is present, then in step 290, the method 200 can end. In some embodiments, the character fingerprinting system can repeat one or more steps of the method 200 on a continual or intermittent basis to generate fingerprinted text compositions and/or to determine whether character fingerprint matches exist between text compositions.

FIG. 3 depicts the representative major components of an exemplary Computer System 301 that can be used in accordance with embodiments of the present disclosure. The particular components depicted are presented for the purpose of example only and are not necessarily the only such variations. The Computer System 301 can comprise a Processor 310, Memory 320, an Input/Output Interface (also referred to herein as I/O or I/O Interface) 330, and a Main Bus 340. The Main Bus 340 can provide communication pathways for the other components of the Computer System 301. In some embodiments, the Main Bus 340 can connect to other components such as a specialized digital signal processor (not depicted).

The Processor 310 of the Computer System 301 can be comprised of one or more CPUs 312. The Processor 310 can additionally be comprised of one or more memory buffers or caches (not depicted) that provide temporary storage of instructions and data for the CPU 312. The CPU 312 can perform instructions on input provided from the caches or from the Memory 320 and output the result to caches or the Memory 320. The CPU 312 can be comprised of one or more circuits configured to perform one or more methods consistent with embodiments of the present disclosure. In some embodiments, the Computer System 301 can contain multiple Processors 310 typical of a relatively large system. In other embodiments, however, the Computer System 301 can be a single processor with a singular CPU 312.

The Memory 320 of the Computer System 301 can be comprised of a Memory Controller 322 and one or more memory modules for temporarily or permanently storing data (not depicted). In some embodiments, the Memory 320 can comprise a random-access semiconductor memory, storage device, or storage medium (either volatile or non-volatile) for storing data and programs. The Memory Controller 322 can communicate with the Processor 310, facilitating storage and retrieval of information in the memory modules. The Memory Controller 322 can communicate with the I/O Interface 330, facilitating storage and retrieval of input or output in the memory modules. In some embodiments, the memory modules can be dual in-line memory modules.

The I/O Interface 330 can comprise an I/O Bus 350, a Terminal Interface 352, a Storage Interface 354, an I/O Device Interface 356, and a Network Interface 358. The I/O Interface 330 can connect the Main Bus 340 to the I/O Bus 350. The I/O Interface 330 can direct instructions and data from the Processor 310 and Memory 320 to the various interfaces of the I/O Bus 350. The I/O Interface 330 can also direct instructions and data from the various interfaces of the I/O Bus 350 to the Processor 310 and Memory 320. The various interfaces can comprise the Terminal Interface 352, the Storage Interface 354, the I/O Device Interface 356, and the Network Interface 358. In some embodiments, the various interfaces can comprise a subset of the aforementioned interfaces (e.g., an embedded computer system in an industrial application may not include the Terminal Interface 352 and the Storage Interface 354).

Logic modules throughout the Computer System 301—including but not limited to the Memory 320, the Processor 310, and the I/O Interface 330—can communicate failures and changes to one or more components to a hypervisor or operating system (not depicted). The hypervisor or the operating system can allocate the various resources available in the Computer System 301 and track the location of data in Memory 320 and of processes assigned to various CPUs 312. In embodiments that combine or rearrange elements, aspects of the logic modules' capabilities can be combined or redistributed. These variations would be apparent to one skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

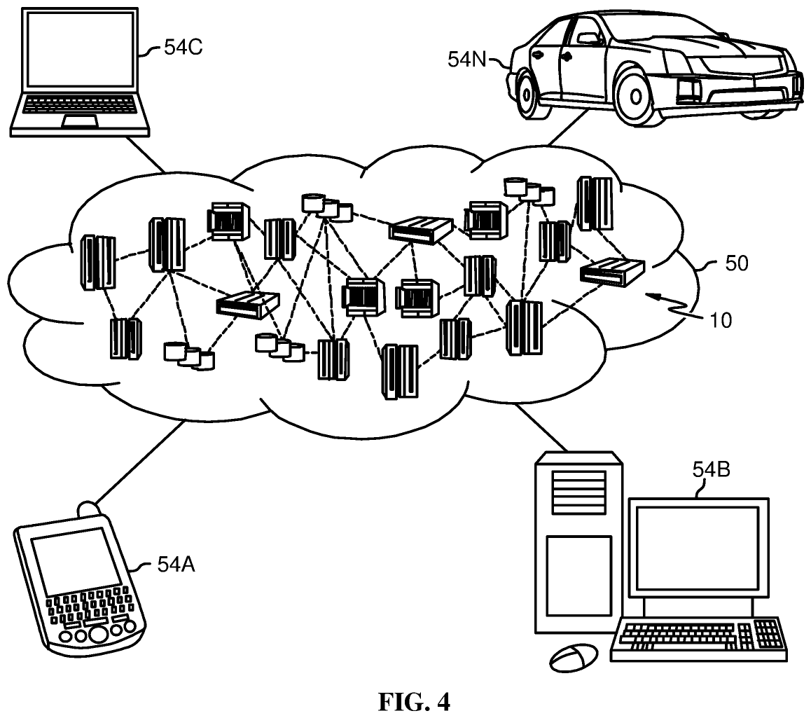

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

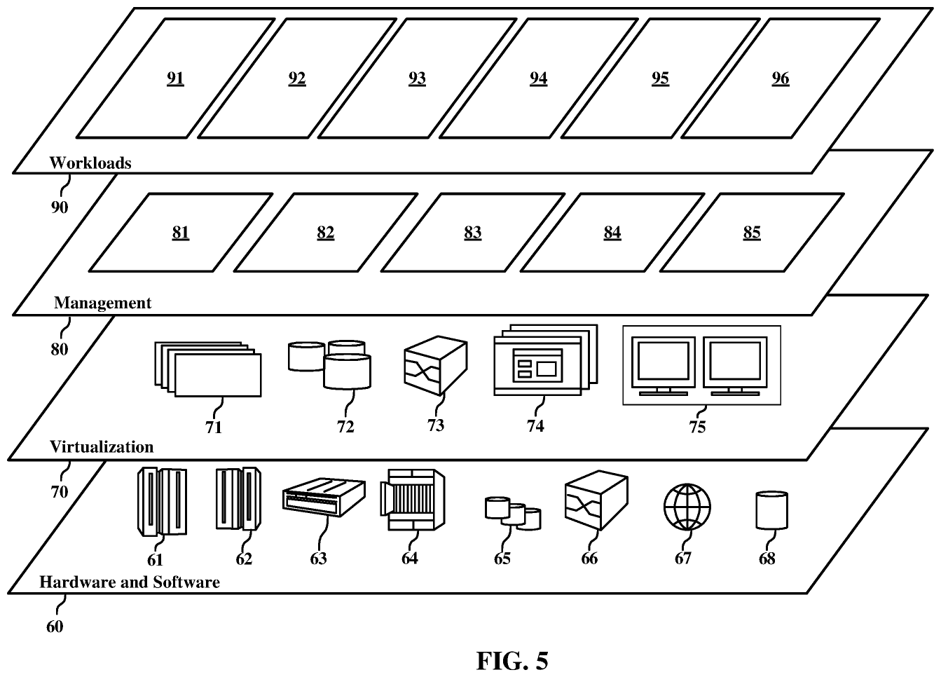

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and character fingerprinting logic 96.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, by a character fingerprinting system, a first text composition;
obtaining, by the character fingerprinting system, first user data of a first user;
generating, by the character fingerprinting system, a first set of character fingerprinting rules that corresponds to the first user; and
performing a first modification, by the character fingerprinting system, of the first text composition, according to the first set of character fingerprinting rules, wherein the first modification results in a first fingerprinted text composition that corresponds to the first user.

2. The computer-implemented method of claim 1, further comprising:
obtaining, by the character fingerprinting system, second user data of a second user;
generating, by the character fingerprinting system, a second set of character fingerprinting rules that corresponds to the second user; and
performing a second modification, by the character fingerprinting system, of the first text composition, according to the second set of character fingerprinting rules, wherein the second modification results in a second fingerprinted text composition that corresponds to the second user.

3. The computer-implemented method of claim 2, further comprising:
transmitting, by the character fingerprinting system, the first fingerprinted text composition to a first user device of the first user; and
transmitting, by the character fingerprinting system, the second fingerprinted text composition to a second user device of the second user.

4. The computer-implemented method of claim 1, wherein generating the first set of character fingerprinting rules comprises generating a hash that corresponds to the first user data.

5. The computer-implemented method of claim 4, wherein the hash comprises a plurality of hash characters, and wherein the character fingerprinting system assigns a character fingerprinting rule to each hash character of the plurality of hash characters.

6. The computer-implemented method of claim 1, further comprising:
obtaining, by the character fingerprinting system, a second text composition;
comparing the second text composition to the first fingerprinted text composition;
detecting a number of fingerprint elements in the second text composition;
determining that the number of detected fingerprint elements exceeds a threshold; and
in response to the determining, generating a notification.

7. The computer-implemented method of claim 6, wherein obtaining the second text composition further comprises performing, by the character fingerprinting system, a search for the second text composition.

8. A character fingerprinting system comprising:
a processor; and
a memory in communication with the processor, the memory containing program instructions that, when executed by the processor, are configured to cause the processor to perform a method, the method comprising:
obtaining, by the character fingerprinting system, a first text composition;
obtaining, by the character fingerprinting system, first user data of a first user;
generating, by the character fingerprinting system, a first set of character fingerprinting rules that corresponds to the first user; and
performing a first modification, by the character fingerprinting system, of the first text composition, according to the first set of character fingerprinting rules, wherein the first modification results in a first fingerprinted text composition that corresponds to the first user.

9. The character fingerprinting system of claim 8, further comprising:
obtaining, by the character fingerprinting system, second user data of a second user;
generating, by the character fingerprinting system, a second set of character fingerprinting rules that corresponds to the second user; and
performing a second modification, by the character fingerprinting system, of the first text composition, according to the second set of character fingerprinting rules, wherein the second modification results in a second fingerprinted text composition that corresponds to the second user.

10. The character fingerprinting system of claim 9, further comprising:
transmitting, by the character fingerprinting system, the first fingerprinted text composition to a first user device of the first user; and
transmitting, by the character fingerprinting system, the second fingerprinted text composition to a second user device of the second user.

11. The character fingerprinting system of claim 8, wherein generating the first set of character fingerprinting rules comprises generating a hash that corresponds to the first user data.

12. The character fingerprinting system of claim 11, wherein the hash comprises a plurality of hash characters, and wherein the character fingerprinting system assigns a character fingerprinting rule to each hash character of the plurality of hash characters.

13. The character fingerprinting system of claim 8, further comprising:
obtaining, by the character fingerprinting system, a second text composition;
comparing the second text composition to the first fingerprinted text composition;
detecting a number of fingerprint elements in the second text composition;
determining that the number of detected fingerprint elements exceeds a threshold; and
in response to the determining, generating a notification.

14. The character fingerprinting system of claim 13, wherein obtaining the second text composition further comprises performing, by the character fingerprinting system, a search for the second text composition.

15. A computer program product, the computer program product comprising a computer readable storage medium having program instructions embodied therewith, the program instructions executable by a computer to cause the computer to:
obtain, by a character fingerprinting system, a first text composition;
obtain, by the character fingerprinting system, first user data of a first user;
generate, by the character fingerprinting system, a first set of character fingerprinting rules that corresponds to the first user; and
perform a first modification, by the character fingerprinting system, of the first text composition, according to the first set of character fingerprinting rules, wherein the first modification results in a first fingerprinted text composition that corresponds to the first user.

16. The computer program product of claim 15, wherein the program instructions, when executed by the computer, are configured to further cause the computer to:
obtain, by the character fingerprinting system, second user data of a second user;
generate, by the character fingerprinting system, a second set of character fingerprinting rules that corresponds to the second user; and
perform a second modification, by the character fingerprinting system, of the first text composition, according to the second set of character fingerprinting rules, wherein the second modification results in a second fingerprinted text composition that corresponds to the second user.

17. The computer program product of claim 16, wherein the program instructions, when executed by the computer, are configured to further cause the computer to:
transmit, by the character fingerprinting system, the first fingerprinted text composition to a first user device of the first user; and
transmit, by the character fingerprinting system, the second fingerprinted text composition to a second user device of the second user.

18. The computer program product of claim 15, wherein generating the first set of character fingerprinting rules comprises generating a hash that corresponds to the first user data.

19. The computer program product of claim 18, wherein the hash comprises a plurality of hash characters, and wherein the program instructions, when executed by the computer, are configured to further cause the computer to assign a character fingerprinting rule to each hash character of the plurality of hash characters.

20. The computer program product of claim 15, wherein the program instructions, when executed by the computer, are configured to further cause the computer to:
obtain, by the character fingerprinting system, a second text composition;
compare the second text composition to the first fingerprinted text composition;
detect a number of fingerprint elements in the second text composition;
determine that the number of detected fingerprint elements exceeds a threshold; and
in response to the determining, generate a notification.
